(19) United States
(12) Patent Application Publication
(10) Pub. No.: US 2009/0276704 A1
(43) Pub. Date: Nov. 5, 2009

(54) PROVIDING CUSTOMER SERVICE HIERARCHIES WITHIN A VIRTUAL UNIVERSE

(76) Inventors: Peter G. Finn, Ontario (CA); Rick A. Hamilton, II, Charlottesville, VA (US); Neil A. Katz, Parkland, FL (US); James W. Seaman, Falls Church, VA (US)

Correspondence Address: HOFFMAN WARNICK LLC, 75 STATE ST, 14TH FLOOR, ALBANY, NY, 12207, US

(21) Appl. No.: 12/112,409

(22) Filed: Apr. 30, 2008

(51) Int. Cl. G06F 3/048

(52) U.S. Cl. 715/706

(57) ABSTRACT

The present invention is directed to providing customer service hierarchies within a virtual universe. A method for providing customer service hierarchies within a virtual universe includes: receiving a customer need request from an avatar; presenting a virtual interactive menu and/or a web page after receiving the customer need request; and if the menu and/or web page does not satisfy the customer's need request, then providing a customer service representative avatar to the avatar in need of customer service. A system, a program product stored on a computer readable medium, and a method for deploying such an application are also disclosed.

### FIELD OF THE INVENTION

The present invention relates generally to improving the customer's experience in a virtual universe, and more specifically relates to providing customer service hierarchies within a virtual universe.

### BACKGROUND OF THE INVENTION

A virtual environment is an interactive simulated environment accessed by multiple users through an online interface. Users inhabit and interact in the virtual environment via avatars, which are two or three-dimensional graphical representations of humanoids. There are many different types of virtual environments. However, there are several features many virtual environments generally have in common:

A) Shared Space: the world allows many users to participate at once.
B) Graphical User Interface: the environment depicts space visually, ranging in style from 2D “cartoon” imagery to more immersive 3D environments.
C) Immediacy: interaction takes place in real time.
D) Interactivity: the environment allows users to alter, develop, build, or submit customized content.
E) Persistence: the environment's existence continues regardless of whether individual users are logged in.
F) Socialization/Community: the environment allows and encourages the formation of social groups such as teams, guilds, clubs, cliques, housemates, neighborhoods, etc.

An avatar can have a wide range of business and social experiences. Such business and social experiences are becoming more common and increasingly important in on-line virtual environments (e.g., universes, worlds, etc.), such as that provided in the on-line world Second Life (Second Life is a trademark of Linden Research in the United States, other countries, or both). The Second Life client program provides its users (referred to as residents) with tools to view, navigate, and modify the Second Life world and participate in its virtual economy.

Second Life and other on-line virtual environments present a tremendous new outlet for both structured and unstructured virtual collaboration, gaming, exploration, commerce, and travel, as well as real-life simulations in virtual spaces. As virtual worlds are providing a new and emerging marketplace for commerce, companies are struggling to determine how best to provide both cost effective and customer friendly methods of serving avatar patrons.

Virtual store-fronts, in particular, pose a unique challenge, in that each avatar represents a real person who may expect the same level of service that one would get in a physical, real commerce environment. While physical commerce environments have a natural limit of customers based on physical attributes (e.g., aisle size, door size, counter space, store size, store hours, etc.), no such barriers exist in the virtual commerce setting. Thus, the dilemma becomes how does one best “staff” a virtual store-front in an effective manner. As traditional bricks and mortar entities, additional users, and legacy web providers, all increasingly move into the virtual universe space, these problems are increasingly compounded.

### SUMMARY OF THE INVENTION

The present invention is directed to providing customer service hierarchies within a virtual universe.

A first aspect of the present invention is directed to a method for providing customer service hierarchies within a virtual universe, comprising: receiving a customer need request from an avatar; upon the receiving, presenting at least one of: a virtual interactive menu, and a web page; and if the presenting does not satisfy the customer need request, providing a customer service representative avatar.

A second aspect of the present invention is directed to a system for providing customer service hierarchies within a virtual universe, comprising: a component for receiving a customer need request from an avatar; a component for presenting at least one of: a virtual interactive menu, and a web page; and a component for providing a customer service representative avatar if the presenting does not satisfy the customer need request.

A third aspect of the present invention is directed to a program product stored on a computer readable medium, which when executed, provides customer service hierarchies within a virtual universe, the computer readable medium comprising program code for: receiving a customer need request from an avatar; upon the receiving, presenting at least one of: a virtual interactive menu, and a web page; and if the presenting does not satisfy the customer need request, providing a customer service representative avatar.

A fourth aspect of the present invention is directed to a method for deploying an application for providing customer service hierarchies within a virtual universe, comprising: providing a computer infrastructure being operable to: receive a customer need request from an avatar; upon the receiving, present at least one of: a virtual interactive menu, and a web page; and if the presenting does not satisfy the customer need request, provide a customer service representative avatar.

A fifth aspect of the present invention is directed to a business method for providing customer service hierarchies within a virtual universe, the business method comprising: managing a network that includes at least one computer system that performs the process described herein; and receiving payment based on the managing.

The illustrative aspects of the present invention are designed to solve the problems herein described and other problems not discussed.

### BRIEF DESCRIPTION OF THE DRAWINGS

These and other features of this invention will be more readily understood from the following detailed description of the various aspects of the invention taken in conjunction with the accompanying drawings.

FIG. 1 depicts a high-level schematic diagram showing a networking environment for providing a virtual universe in accordance with an embodiment of the present invention.

FIG. 2 depicts a more detailed view of a virtual region shown in the virtual universe of FIG. 1 in accordance with an embodiment of the present invention.

FIG. 3 depicts a more detailed view of a portion of the virtual region shown in FIG. 2 in accordance with an embodiment of the present invention.

FIG. 4 depicts a more detailed view of the virtual universe client shown in FIG. 1 in accordance with an embodiment of the present invention.

FIG. 5 depicts a more detailed view of some of the functionalities provided by the server array shown in FIG. 1 in accordance with an embodiment of the present invention.

FIG. 6 depicts a more detailed view of a customer service tool in FIG. 5 in accordance with an embodiment of the present invention.

FIG. 7A depicts a virtual interactive menu presented by the customer service tool in accordance with an embodiment of the present invention.

FIG. 7B depicts a web page presented by the customer service tool in accordance with an embodiment of the present invention.

FIG. 7C depicts a customer service representative avatar provided by the customer service tool in accordance with an embodiment of the present invention.

FIG. 8A depicts a first portion of a process flow for providing customer service hierarchies within a virtual universe in accordance with an embodiment of the present invention.

FIG. 8B depicts a second portion of a process flow for providing customer service hierarchies within a virtual universe in accordance with an embodiment of the present invention.

FIG. 9 depicts an illustrative computer system for implementing embodiment(s) of the present invention.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

As detailed above, the present invention provides customer service hierarchies within a virtual universe. Aspects of the invention provide a tiered method of automated information access in a virtual world where requests that are not satisfied by automated methods are transparently queued to a live customer service representative. This provides a low-cost front-end to virtual patrons, while also providing the requisite level of service when the automated communications do not sufficiently meet the customer's needs.

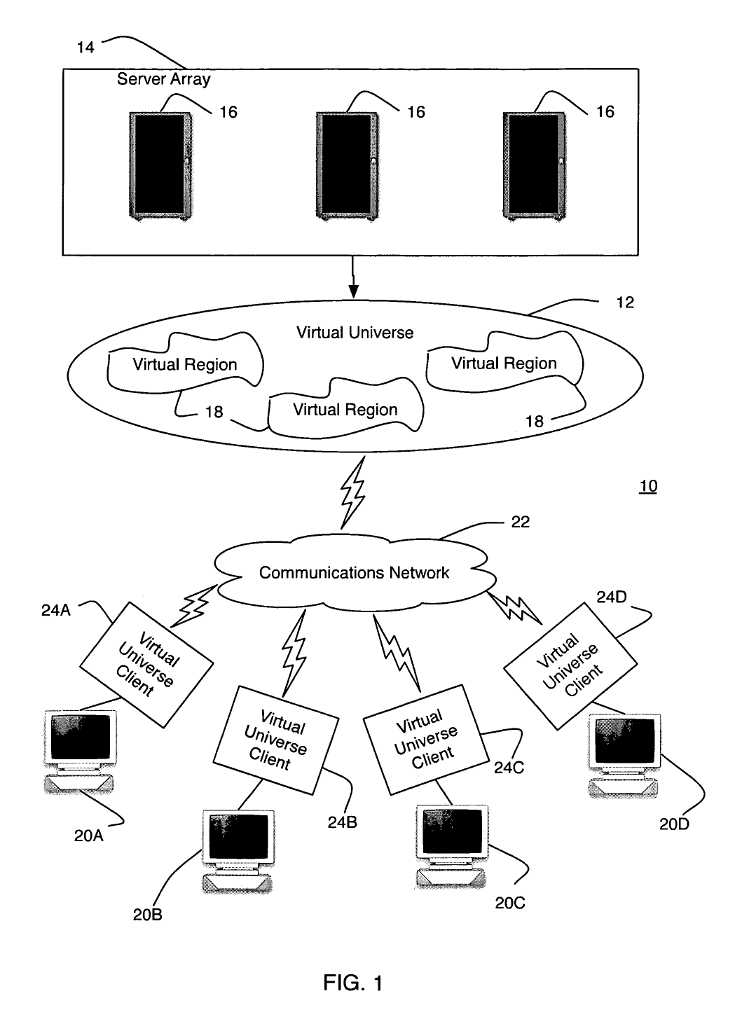

FIG. 1 shows a high-level schematic diagram showing a networking environment 10 for providing a virtual universe 12 according to one embodiment of this invention in which a service for providing customer service hierarchies within the virtual universe can be utilized. As shown in FIG. 1, the networking environment 10 comprises a server array or grid 14 comprising a plurality of servers 16 each responsible for managing a portion of virtual real estate within the virtual universe 12. A virtual universe provided by a typical massively multiplayer on-line game can employ thousands of servers to manage all of the virtual real estate. The content of the virtual real estate that is managed by each of the servers 16 within the server array 14 shows up in the virtual universe 12 as a virtual region 18. Like the real-world, each virtual region 18 within the virtual universe 12 comprises a living landscape having things such as buildings, stores, clubs, sporting arenas, parks, beaches, cities and towns all created by residents of the universe that are represented by avatars. These examples of items are only illustrative of some things that may be found in a virtual region and are not limiting. Furthermore, the number of virtual regions 18 shown in FIG. 1 is only for illustration purposes and those skilled in the art will recognize that there may be many more regions found in a typical virtual universe. FIG. 1 also shows that users operating computers 20 (e.g., 20A, 20B, 20C, 20D) interact with the virtual universe 12 through a communication network 22 via a virtual universe client 24 (e.g., 24A, 24B, 24C, 24D) that resides in the computer. Below are further details of the virtual universe 12, server array 14, and virtual universe client 24A, 24B, 24C, 24D.

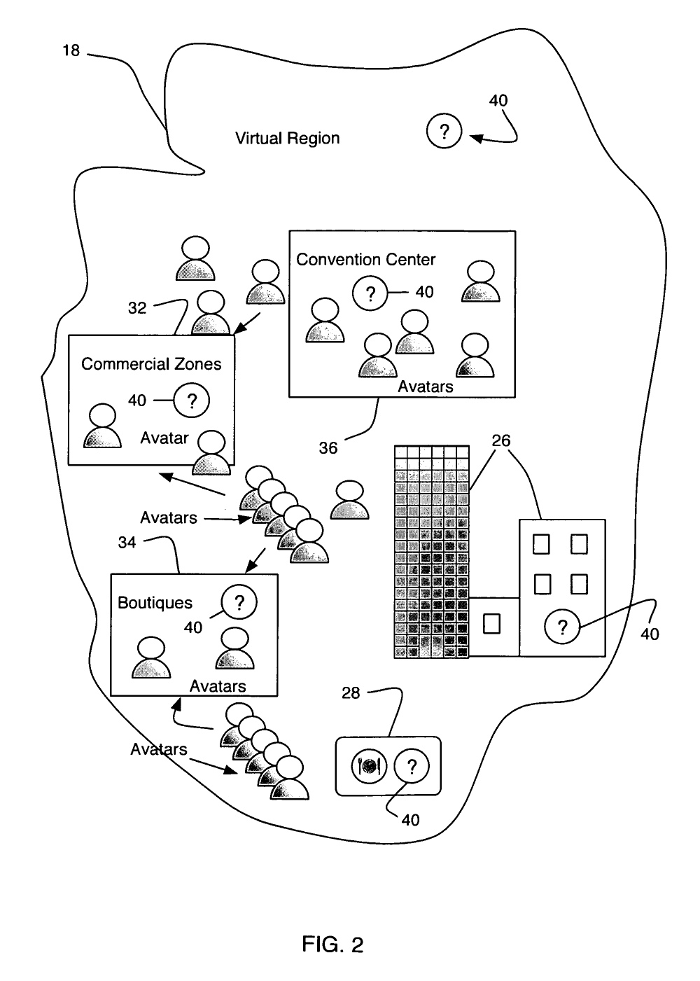

FIG. 2 shows a more detailed view of a virtual region shown 18 in the virtual universe 12 of FIG. 1 with avatars concentrated in various locations of the virtual region. As an example, the virtual region 18 shown in FIG. 2 comprises a downtown office center 26, restaurants 28 commercial zones 32 and boutiques 34 for shopping and a convention center 36 for meetings and various conventions. Also located in the virtual region 18 and/or within the various sub-elements (e.g., downtown office center 26, restaurants 28 commercial zones 32 and boutiques 34, convention center 36, etc.) may be an information location 40. These examples of items in the virtual region 18 shown in FIG. 2 are only illustrative of some things that may be found in a virtual region 18 and those skilled in the art will recognize that these regions can have many more items that can be found in a real-life universe as well as things that do not presently exist in real life.

Residents or avatars which as mentioned above are personas or representations of the users of the virtual universe, roam all about the virtual region by walking, driving, flying or even by teleportation or transportation which is essentially moving through space from one point to another, more or less instantaneously. As shown in FIG. 2, there is a large concentration of avatars in or near the convention center 36, and there are a few avatars at the commercial zones 32 and at the boutique 34 and none at the downtown office center 26 and restaurants 28. Several avatars and/or a group of avatars are queued up to enter the commercial zone 32 and/or the boutique 34. This may cause, amongst other items, an undesirable backlog and delay at the commercial zone 32 and boutique 34. If not satisfactorily addressed by the commercial zone 32 and/or boutique 34, the avatar(s) may seek to satisfy their needs (commercial or otherwise) at other establishments. In any event, aspects of the method provide customer service hierarchies within the virtual universe 12.

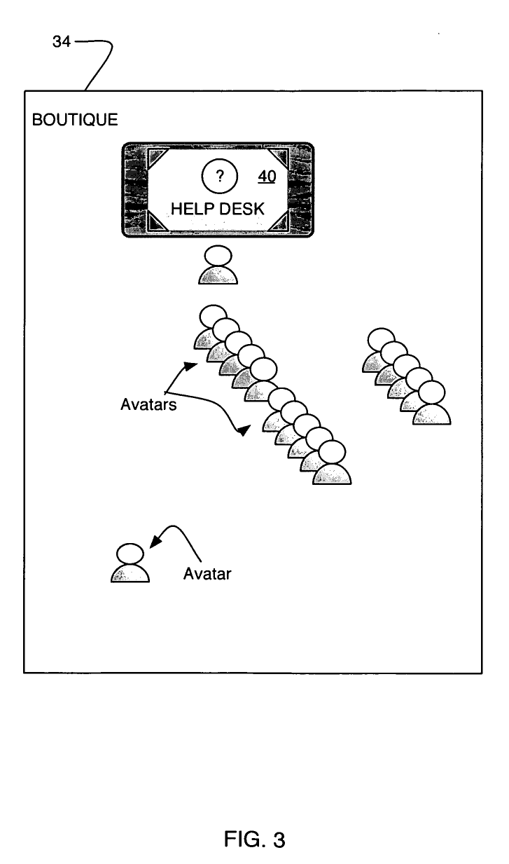

As more specifically shown in FIG. 3, an avatar, or group of avatars, may have a need of some sort within the virtual universe 12. For example, a single avatar in FIG. 3 may be in a boutique 34 and has a particular need. As such, this avatar may go to a customer service area 40 (e.g., “help desk”) in order to get the need addressed. The need could be virtually anything. For example, it may be a question, a complaint, a request for information, a transaction, and/or the like. Similarly, the customer need request does not have to be obtained via going to a help desk, as shown in FIG. 3. As discussed herein, there are a near infinite variety of ways for rendering customer service under aspects of the present invention.

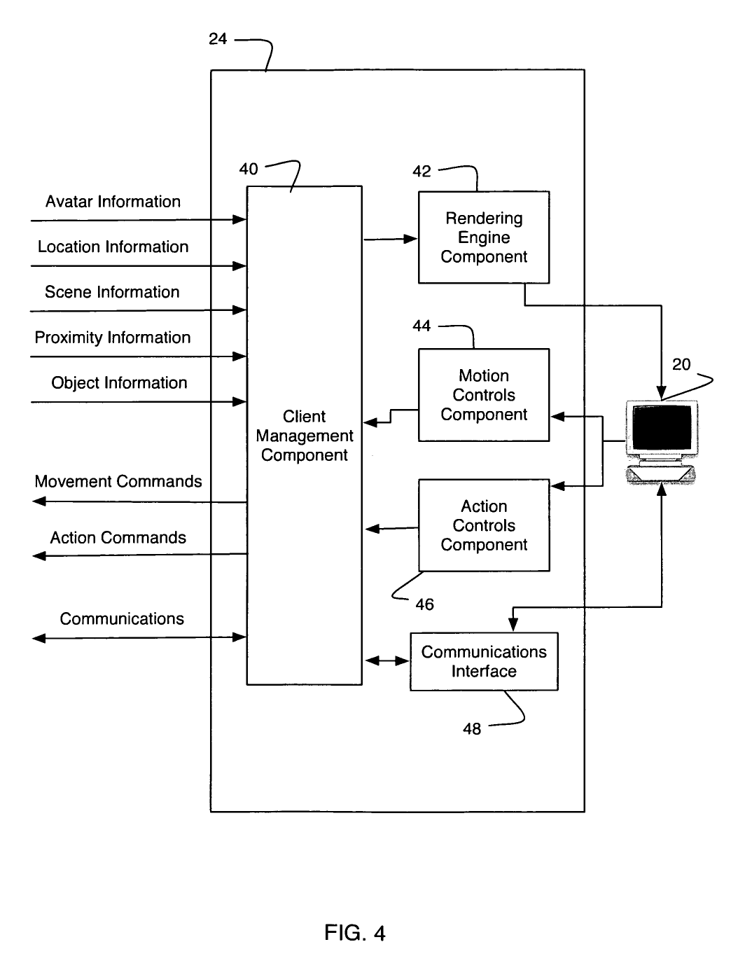

FIG. 4 shows a more detailed view of the virtual universe clients 24A, 24B, 24C, 24D shown in FIG. 1. The virtual universe client 24, which enables users to interact with the virtual universe 12, comprises a client management component 40, which manages actions, movements and communications made by a user through computer 20 (e.g., 20A, 20B, 20C, 20D at FIG. 1), and information received from the virtual universe through the server array 14. A rendering engine component 42 enables the user of the computer 20 to visualize his or her avatar within the surroundings of the particular region of the virtual universe 12 that it is presently located. A motion controls component 44 enables the user to make movements through the virtual universe. In one embodiment, movements through the virtual universe can include for example, gestures, postures, walking, running, driving, flying, etc.

An action controls component 46 enables the user to perform actions in the virtual universe such as buying items for his or her avatar or even for their real-life selves, building homes, planting gardens, etc., as well as changing the appearance of their avatar. These actions are only illustrative of some possible actions that a user can perform in the virtual universe and are not limiting of the many possible actions that can be performed. A communications interface 48 enables a user to communicate with other users of the virtual universe 12 through modalities such as chatting, instant messaging, gesturing, talking and email.

FIG. 4 shows various information that may be received by the client management component 40 from the virtual universe through the server array 14. In particular, the client management component 40 receives avatar information about the avatars that are in proximity to the user's avatar. In addition, the client management component 40 receives location information about the area that the user's avatar is near (e.g., what region or island he or she is in) as well as scene information (e.g., what the avatar sees). The client management component 40 also receives proximity information which contains information on what the user's avatar is near and object information which is information that can be obtained by one's senses (e.g., touch, taste, smell, etc., and what actions are possible for nearby objects (e.g., postures, movements). FIG. 4 also shows the movement commands and action commands that are generated by the user that are sent to the server array via the client management component 40, as well as the communications that can be sent to the users of other avatars within the virtual universe.

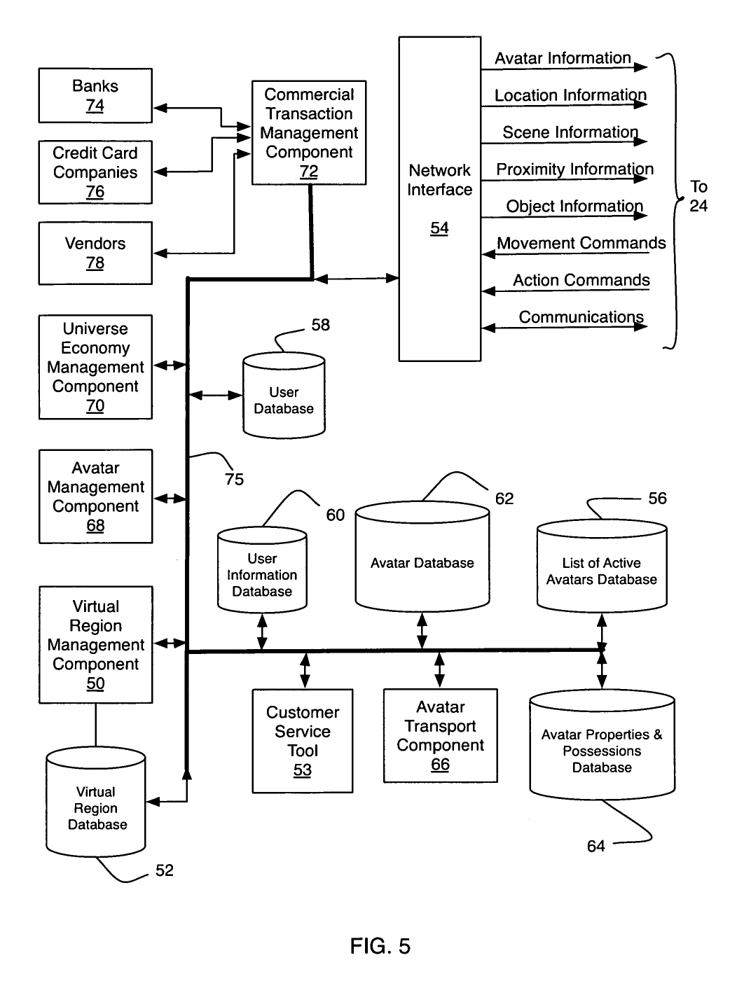

FIG. 5 shows a more detailed view of some of the functionalities provided by the server array 14 shown in FIG. 1. In particular, FIG. 5 shows a virtual region management component 50 that manages a virtual region within the virtual universe. In particular, the virtual region management component 50 manages what happens in a particular region such as the type of landscape in that region, the amount of homes, commercial zones, boutiques, bridges, highways, streets, parks, restaurants, etc. A virtual region database 52 stores information on all of the items in the virtual region 18 that the virtual region management component 50 is managing. In one embodiment, for very large virtual universes, one server 16 may be responsible for managing one particular virtual region 18 within the universe. In other embodiments, it is possible that one server 16 may be responsible for handling one particular island within the virtual region 18.

A customer service tool 53 provides customer service hierarchies in the virtual universe 12. Below is a more detailed discussion of the customer service tool 53 and how it provides customer service hierarchies within a virtual universe 12, including a discussion on how the tool 53 receives customer need requests; presents virtual interactive menu(s) and/or web page(s) to the customer; and further provides a customer service representative avatar should the menu(s) and web page(s) not satisfy the customer's needs.

FIG. 5 shows a network interface 54 that enables the server array 14 to interact with the virtual universe client 24 residing on computer 20. In particular, the network interface 54 communicates information that includes information pertaining to avatars, location, trajectory, scene, proximity and objects to the user through the virtual universe client 24 and receives movement and action commands as well as communications from the user via the universe client.

As shown in FIG. 5, there are several different databases for storing information. In particular, database 56 contains a list of all the avatars that are on-line in the virtual universe 12. Databases 58 and 60 contain information on the actual human users of the virtual universe 12. In one embodiment, database 58 contains general information on the users such as names, addresses, interests, ages, etc., while database 60 contains more private information on the users such as email addresses, billing information (e.g., credit card information) for taking part in transactions. Databases 62 and 64 contain information on the avatars of the users that reside in the virtual universe 12. In one embodiment, database 62 contains information such as all of the avatars that a user may have, the profile of each avatar, avatar characteristics (e.g., appearance, voice and movement features), while database 64 contains an inventory listing properties and possessions that each avatar owns such as houses, cars, sporting equipment, appearance, attire, etc. Those skilled in the art will recognize that databases 58-64 may contain additional information if desired. Although the above information is shown in FIG. 5 as being stored in databases, those skilled in the art will recognize that other means of storing information can be utilized.

An avatar transport component 66 enables individual avatars to transport, which as mentioned above, allows avatars to transport through space from one point to another point, instantaneously. For example, avatars could teleport to an art exhibit held in a museum held in Greenland.

An avatar management component 68 keeps track of what on-line avatars are doing while in the virtual universe. For example, the avatar management component 68 can track where the avatar presently is in the virtual universe, what activities it is performing or has recently performed. An illustrative but non-exhaustive list of activities can include shopping, eating, talking, recreating, etc.

Because a typical virtual universe has a vibrant economy, the server array 14 has functionalities that are configured to manage the economy. In particular, a universe economy management component 70 manages transactions that occur within the virtual universe between avatars. In one embodiment, the virtual universe 12 will have their own currency that users pay for with real-life money. The users can then take part in commercial transactions for their avatars through the universe economy management component 70. In some instances, the user may want to take part in a commercial transaction that benefits him or her and not their avatar. In this case, a commercial transaction management component 72 allows the user to participate in the transaction. For example, while walking around a commercial zone, an avatar may see a pair of shoes that he or she would like for themselves and not their avatar. In order to fulfill this type of transaction and others similarly related, the commercial transaction management component 72 interacts with banks 74, credit card companies 76 and vendors 78 to facilitate such a transaction.

The components in FIG. 5 are all interconnected via an interconnect 75. Although shown in FIG. 5 as connected via interconnect 75, all of the components may be configured to interact with each other using other means now known or later developed. The components that are shown as being interconnected via interconnect 75 are illustrated in that manner to convey the close interactions that exist between these components such as the banks 74, credit card companies 76, and vendors with the commercial transaction management component 72.

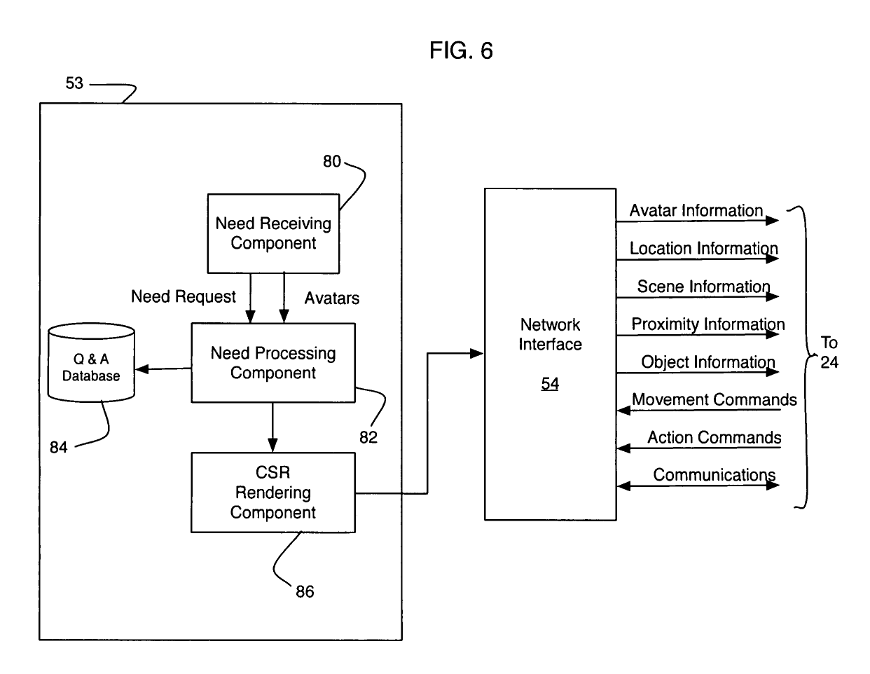

FIG. 6 shows a more detailed view of a customer service tool 53 shown in FIG. 5 according to one embodiment of this invention. As mentioned above, the user customer service tool 53 provides customer service hierarchies within a virtual universe 12. As shown in FIG. 6, in one embodiment, the customer service tool 53 resides on a computer system that is a part of the server array 14 and communicates directly to the virtual universe and its residents via the virtual universe client 24. In other embodiments, the customer service tool 53 might reside on separate computers in direct communication with the virtual universe servers 16 and universe clients 24.

The customer service tool 53 comprises a need receiving component 80 configured to receive customer need request(s) of at least one avatar within the virtual universe 12. The user need receiving component 80 is configured to also monitor the virtual universe 12 for any customer need request(s). By monitoring the virtual universe 12, the need receiving component 80 can detect any customer need request. The customer need request may be evidenced by at least one of: an action, text, a voice, and combinations thereof. For example, referring back to FIGS. 2 and 3, the customer need request may be evidenced by the avatar locating him/herself at a help desk 40 (e.g., action). Similarly, the avatar may voice their desire for a customer need (e.g., voice). Alternatively, the avatar may type a question (e.g., text). In still another embodiment the need receiving component 80 may detect a customer need request based on the action, voice, and/or text of a group of avatars. For example, if a group of avatars exceeding a predetermined quantity are in a specific location (e.g., at a door) for a predetermined amount of time, then the need receiving component 80 is configured to detect and determine, base on the aforementioned, that a customer need request exists. Other embodiments of actions, text, and/or voice items for creating a detectable customer need request are part and parcel of the present invention.

A need processing component 82 is configured to receive the customer need request(s) from the need receiving component 80 and use this data (e.g., avatar, questions, replies, etc.) to process them. In particular, the need processing component 82 may store the need requests in a question and answer (“Q & A”) database 84. The need processing component 82 may further process the customer need request including determining what customer service response is best suited for the customer need request. The customer service response may be, for example, one of a menu, a web page, various customer service representative avatar(s), and/or combinations thereof.

The Q & A database 84 coupled to the need processing component 82 contains data such as an avatar, or group of avatars' questions, movements, locations, proximity to items and/or other avatars, answers, needs, expressions, and/or the like. Although not shown in FIG. 6, the Q & A database 84 receives information directly from other components in the virtual universe server 16 such as location information, scene information, proximity information, object information, etc.

Referring back to FIG. 6, the customer service tool 53 further comprises a customer service representative (CSR) rendering component 86 configured to render and/or present the applicable response to the customer need request received in the virtual universe 12. The CSR rendering component 86 is configured to provide a physical rendering of any one of the requisite responses to the customer need request. In various embodiments, the rendering can be of, for example, a virtual interactive menu, a web page(s), various customer service representatives, combinations thereof, and/or the like.

Aspects of the invention provide a staged approach for providing information to an avatar, or group of avatars, in the virtual universe 12. One goal is to meet the customer service requirements of the avatar with the lowest cost method, and, only as necessary, promote communication methods to more responsive and concomitantly more expensive communication methods. While the last (and most expensive) method of responding to the customer need is to render a live customer service representative (CSR) (e.g., human controlling the CSR real-time), the CSR may redirect or transfer the avatar back to a lower cost method where known response to the avatar's interest is available.

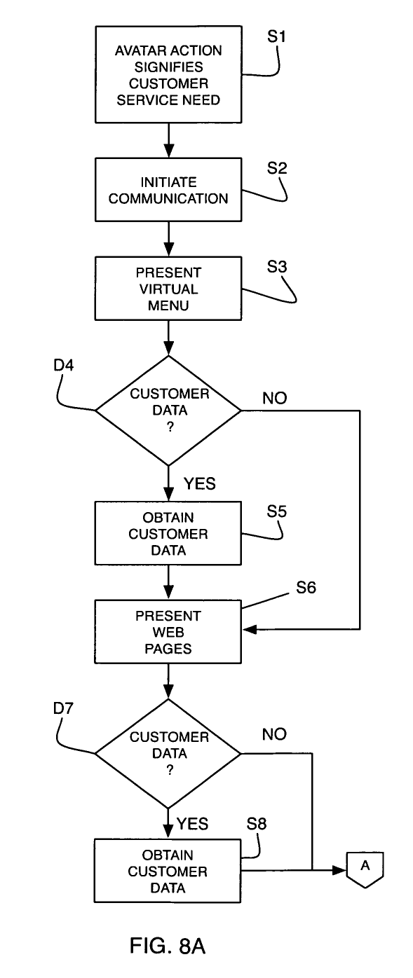

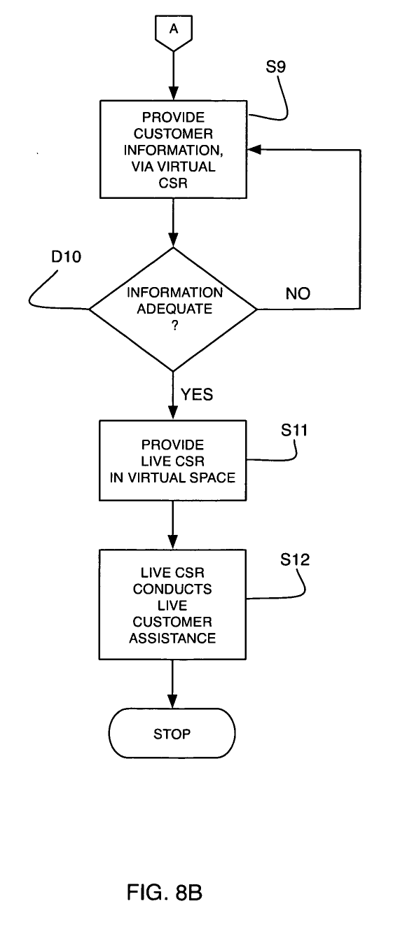

Referring to FIGS. 8A and 8B, which depict an embodiment of a method of providing customer service hierarchies with a virtual universe 12. As discussed herein an avatar, or group of avatars, action signifies a need for communication/customer service. Such actions may include entering a virtual store, asking a question, typing, moving to a location, etc. At S1 the avatar's actions signifies a customer service need. The avatar(s) may be monitored for a triggering action to be detected, Upon obtaining of the customer service need at S1, communication is initiated at S2.

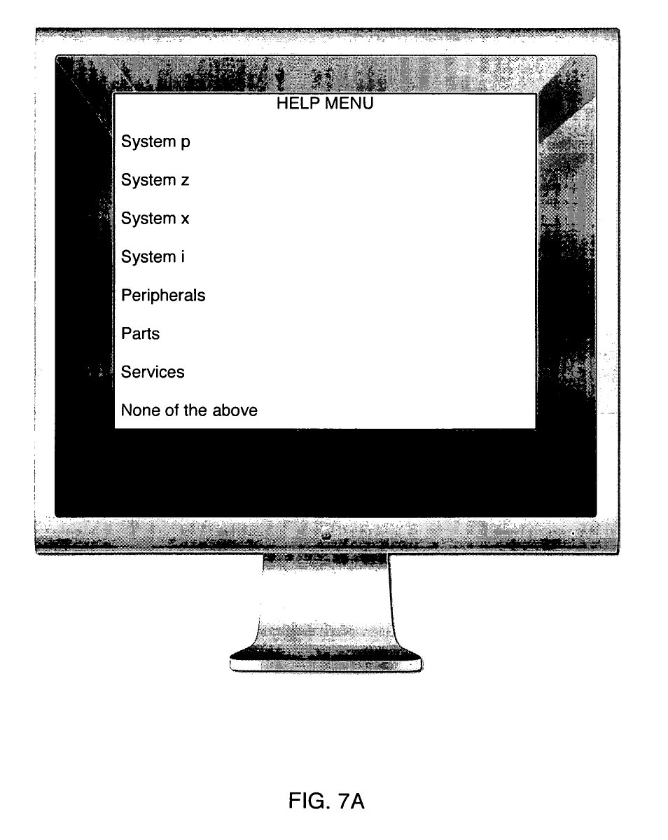

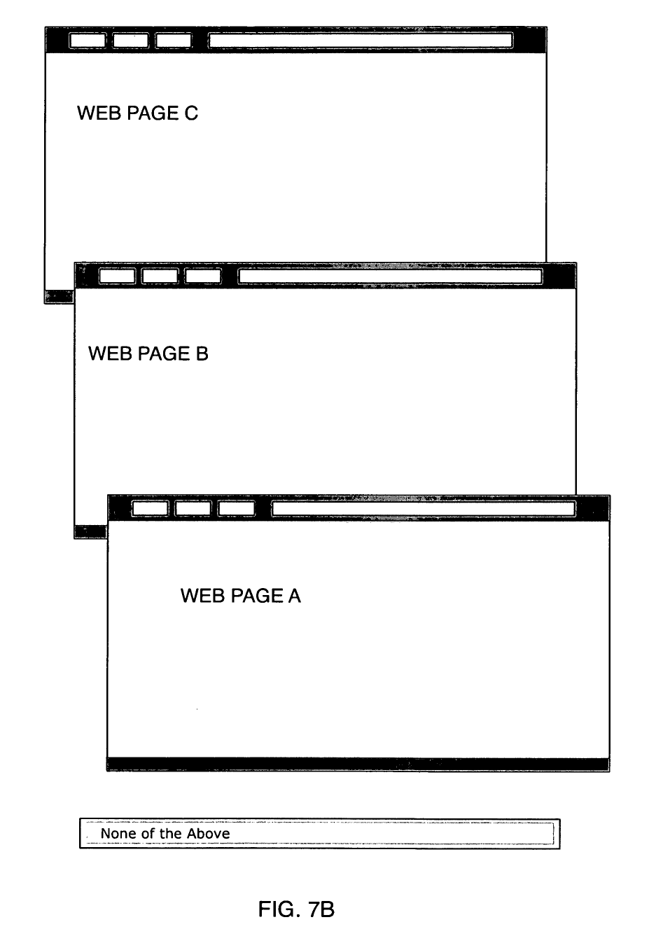

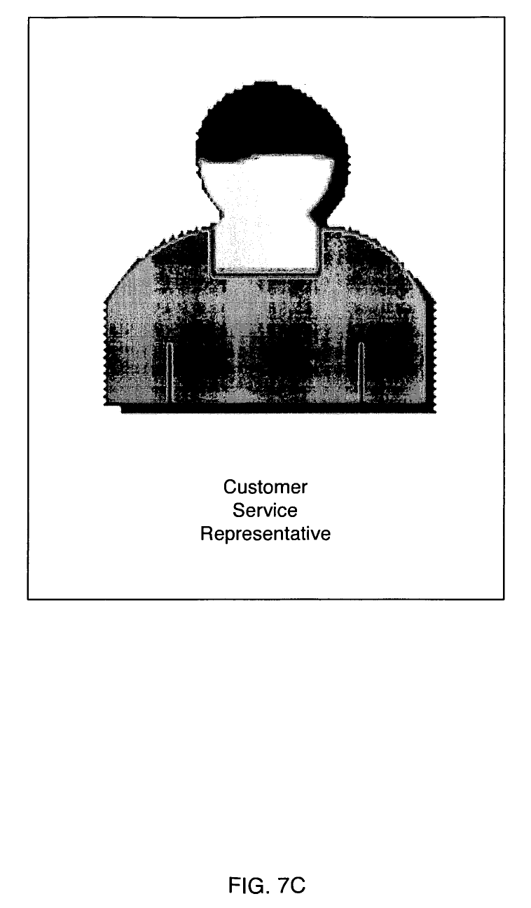

The lowest cost method of customer service may be offered first, thereby providing the first ‘filter’ level of customer service. As such, at S3 a virtual menu is presented. An exemplary virtual menu is depicted at FIG. 7A. The virtual menu includes various choices, such as, “System p”; “System z”; “System x”; “System i”; “Peripherals”; “Parts”; “Services”; and “None of the above”. Each of these menu options may be linked to an existing frequently asked question data repository (e.g., Q&A database 84) within the virtual universe 12. As such, many general inquiries by the avatar may be satisfied at this level. This is also likely to be the best performing search, in that, the virtual universe 12 client addresses the request directly and it is not necessary to start or involve any external interface. It should be understood that the search order presented here may generally occur in another order; may vary in order based on virtual universe 12 location; and/or may be dynamically modified based on trigger type and/or similar criteria.

At D4 and S5, the virtual menu and its concomitant FAQ links are traversed to obtain customer data and satisfy the customer need request. Alternatively, “None of the above” is selected (e.g., manually or automatically based on a failed search) and the next level (e.g., web pages) are presented at S6.

FIG. 7B depict examples of web pages (e.g., “Web Page A”; “Web Page B”; and “Web Page C”) presented. The web pages may be offered based on trigger criteria. For example, if an Avatar entered a virtual IBM® store and asked for information on IBM® products, the following web-based resources may be presented: IBM® server homepage; IBM® storage homepage; IBM® service homepage; and “none of the above”. IBM® As with the virtual menus discussed herein, at D7 and S8, the web pages are selected and traversed to obtain customer data and further satisfy the customer need request. Alternatively, “None of the above” is selected (e.g., manually or automatically based on a failed search) and the next level (e.g., virtual customer service representative) are presented at S9.

An example of a virtual customer service representative (CSR) is depicted at FIG. 7C. The virtual CSR is presented to the avatar and using existing Q&A/search-engine technology, an automated interactive session is established in order to attempt to provide the require information and satisfy the customer need request. At this stage, since the first two search methods field to fully address the customer need request, an attempt is made to acquire additional information from the avatar by parsing the questions, comments, matching keywords or their synonyms with terms in the Q&A database 84. At this level the virtual CSR may be able to provide an answer, or may demote or promote communication methods based on results obtained. Additionally, upon the avatar leaving a triggering location, a mechanism (e.g., a pop-up, a survey, etc.) may be generated asking the avatar if the customer need request has been successfully obtained. At D10 the avatar is queried as to whether the information (e.g., response to the customer need request) is obtained. For example, the virtual CSR may ask the avatar “did this answer your question?” after providing information in order to determine completion and success of the communication.

Based on missed data (e.g., key words not recognized, no solution after “X” number of automated attempts, etc.), the next level is initiated at S11 wherein an on-duty, supplemental stand-by, or “live” CSR is provided in virtual space and presented with a transactional history. The live CSR conducts a live customer assistance session with the avatar at S12.

All of these communication entry points may occur based on avatar action, text, and/or voice triggers. Additionally, any preceding avatar search actions may be maintained (e.g., Q&A database 84) such that during promotion or demotion duplicate data would not be presented to the avatar. For example, if a FAQ were presented during a communication session on IBM® p595 servers and the avatar was not interested, when the session is promoted to the virtual CSR, this FAQ would not be presented again ever if it were called-out by the search criteria. Ultimately, aspects of the invention provide value to users of a virtual world by presenting information in an efficient order, and to the owners and/or sponsors of the virtual world by presenting information in a staged approach beginning with methods that require the fewest computing and human resources thus reducing overall cost.

In another embodiment of this invention, the customer service tool 53 is used as a service to charge fees for each user, or group of users, that seeks help for a customer need request or possibly for each customer service representative rendering that is provided. In this embodiment, the provider of the virtual universe or a third party service provider could offer this customer service tool 53 as a service by performing the functionalities described herein on a subscription and/or fee basis. In this case, the provider of the virtual universe or the third party service provider can create, deploy, maintain, support, etc., the customer service tool 53 that performs the processes described in the invention. In return, the virtual universe or the third party service provider can receive payment from the virtual universe residents via the universe economy management component 70 and the commercial transaction management component 72.

In still another embodiment, the methodologies disclosed herein can be used within a computer system to provide customer service hierarchies within a virtual universe. In this case, the customer service tool 53 can be provided and one or more systems for performing the processes described in the invention can be obtained and deployed to a computer infrastructure. To this extent, the deployment can comprise one or more of (1) installing program code on a computing device, such as a computer system, from a computer-readable medium; (2) adding one or more computing devices to the infrastructure; and (3) incorporating and/or modifying one or more existing systems of the infrastructure to enable the infrastructure to perform the process actions of the invention.

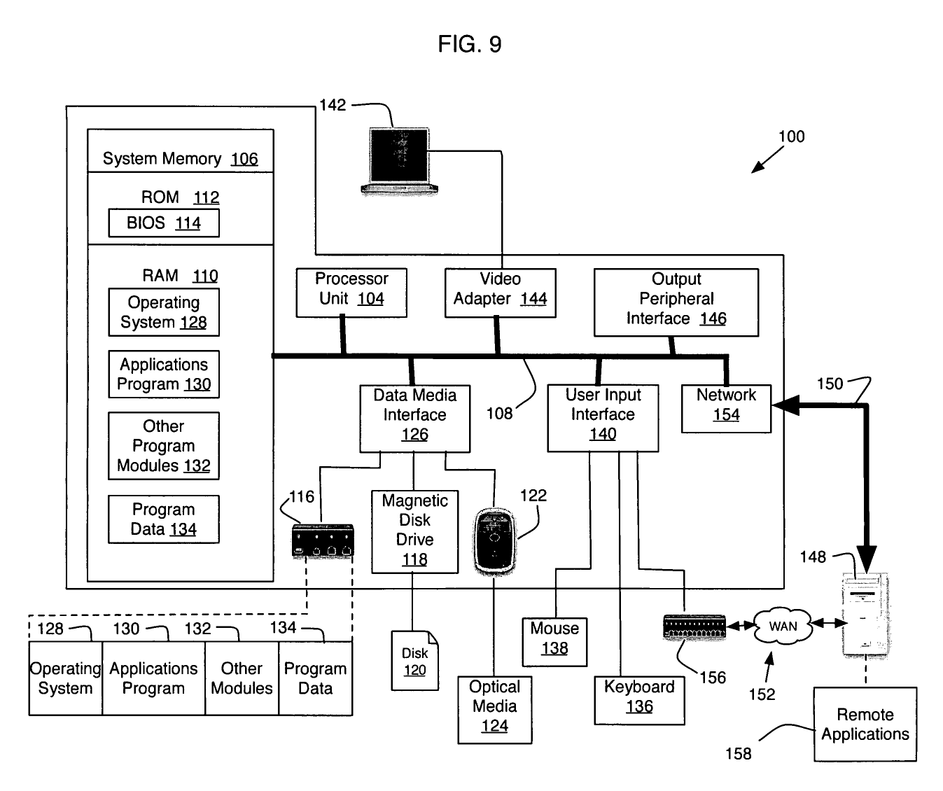

FIG. 9 shows a schematic of an exemplary computing environment in which elements of the networking environment shown in FIG. 1 may operate. The exemplary computing environment 100 is only one example of a suitable computing environment and is not intended to suggest any limitation as to the scope of use or functionality of the approach described herein. Neither should the computing environment 100 be interpreted as having any dependency or requirement relating to any one or combination of components illustrated in FIG. 9.

In the computing environment 100 there is a computer 102 which is operational with numerous other general purpose or special purpose computing system environments or configurations. Examples of well known computing systems, environments, and/or configurations that may be suitable for use with an exemplary computer 102 include, but are not limited to, personal computers, server computers, thin clients, thick clients, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The exemplary computer 102 may be described in the general context of computer-executable instructions, such as program modules, being executed by a computer. Generally, program modules include routines, programs, objects, components, logic, data structures, and so on, that performs particular tasks or implements particular abstract data types. The exemplary computer 102 may be practiced in distributed computing environments where tasks are performed by remote processing devices that are linked through a communications network. In a distributed computing environment, program modules may be located in both local and remote computer storage media including memory storage devices.

As shown in FIG. 9, the computer 102 in the computing environment 100 is shown in the form of a general-purpose computing device. The components of computer 102 may include, but are not limited to, one or more processors or processing units 104, a system memory 106, and a bus 108 that couples various system components including the system memory 106 to the processor 104.

Bus 108 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

The computer 102 typically includes a variety of computer readable media. Such media may be any available media that is accessible by computer 102, and it includes both volatile and non-volatile media, removable and non-removable media.

In FIG. 9, the system memory 106 includes computer readable media in the form of volatile memory, such as random access memory (RAM) 110, and/or non-volatile memory, such as ROM 112. A BIOS 114 containing the basic routines that help to transfer information between elements within computer 102, such as during start-up, is stored in ROM 112. RAM 110 typically contains data and/or program modules that are immediately accessible to and/or presently operated on by processor 104.

Computer 102 may further include other removable/non-removable, volatile/non-volatile computer storage media. By way of example only, FIG. 9 illustrates a hard disk drive 116 for reading from and writing to a non-removable, non-volatile magnetic media (not shown and typically called a “hard drive”), a magnetic disk drive 118 for reading from and writing to a removable, non-volatile magnetic disk 120 (e.g., a “floppy disk”), and an optical disk drive 122 for reading from or writing to a removable, non-volatile optical disk 124 such as a CD-ROM, DVD-ROM or other optical media. The hard disk drive 116, magnetic disk drive 118, and optical disk drive 122 are each connected to bus 108 by one or more data media interfaces 126.

The drives and their associated computer-readable media provide nonvolatile storage of computer readable instructions, data structures, program modules, and other data for computer 102. Although the exemplary environment described herein employs a hard disk 116, a removable magnetic disk 118 and a removable optical disk 122, it should be appreciated by those skilled in the art that other types of computer readable media which can store data that is accessible by a computer, such as magnetic cassettes, flash memory cards, digital video disks, RAMs, ROM, and the like, may also be used in the exemplary operating environment.

A number of program modules may be stored on the hard disk 116, magnetic disk 120, optical disk 122, ROM 112, or RAM 110, including, by way of example, and not limitation, an operating system 128, one or more application programs 130, other program modules 132, and program data 134. Each of the operating system 128, one or more application programs 130, other program modules 132, and program data 134 or some combination thereof, may include an implementation of the networking environment 10 of FIG. 1 including the server array 14, the virtual universe client 24 and the customer service tool 53.

A user may enter commands and information into computer 102 through optional input devices such as a keyboard 136 and a pointing device 138 (such as a “mouse”). Other input devices (not shown) may include a microphone, joystick, game pad, satellite dish, serial port, scanner, camera, or the like. These and other input devices are connected to the processor unit 104 through a user input interface 140 that is coupled to bus 108, but may be connected by other interface and bus structures, such as a parallel port, game port, or a universal serial bus (USB).

An optional monitor 142 or other type of display device is also connected to bus 108 via an interface, such as a video adapter 144. In addition to the monitor, personal computers typically include other peripheral output devices (not shown), such as speakers and printers, which may be connected through output peripheral interface 146.

Computer 102 may operate in a networked environment using logical connections to one or more remote computers, such as a remote server/computer 148. Remote computer 148 may include many or all of the elements and features described herein relative to computer 102.

Logical connections shown in FIG. 9 are a local area network (LAN) 150 and a general wide area network (WAN) 152. Such networking environments are commonplace in offices, enterprise-wide computer networks, intranets, and the Internet. When used in a LAN networking environment, the computer 102 is connected to LAN 150 via network interface or adapter 154. When used in a WAN networking environment, the computer typically includes a modem 156 or other means for establishing communications over the WAN 152. The modem, which may be internal or external, may be connected to the system bus 108 via the user input interface 140 or other appropriate mechanism.

In a networked environment, program modules depicted relative to the personal computer 102, or portions thereof, may be stored in a remote memory storage device. By way of example, and not limitation, FIG. 9 illustrates remote application programs 158 as residing on a memory device of remote computer 148. It will be appreciated that the network connections shown and described are exemplary and other means of establishing a communications link between the computers may be used.

An implementation of an exemplary computer 102 may be stored on or transmitted across some form of computer readable media. Computer readable media can be any available media that can be accessed by a computer. By way of example, and not limitation, computer readable media may comprise “computer storage media” and “communications media.”

“Computer storage media” include volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically embodies computer readable instructions, data structures, program modules, or other data in a modulated data signal, such as carrier wave or other transport mechanism. Communication media also includes any information delivery media.

The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above are also included within the scope of computer readable media.

It is apparent that there has been provided with this invention an approach for providing customer service in a virtual universe. While the invention has been particularly shown and described in conjunction with a preferred embodiment thereof, it will be appreciated that variations and modifications will occur to those skilled in the art. Therefore, it is to be understood that the appended claims are intended to cover all such modifications and changes as fall within the true spirit of the invention.

What is claimed is:

1. A method for providing customer service hierarchies within a virtual universe, comprising:
receiving a customer need request from an avatar;
upon the receiving, presenting at least one of:
a virtual interactive menu, and
a web page; and
if the presenting does not satisfy the customer need request, providing a customer service representative avatar.

2. The method of claim 1, if the customer service representative avatar does not satisfy the customer need request, providing a live, real-time customer server representative.

3. The method of claim 2, upon the live customer service representative satisfying at least one aspect of the customer need request, returning the avatar to one of: the virtual menu, the web page, and the customer service representative avatar.

4. The method of claim 2, wherein live customer service representative is presented in one of the virtual universe and a live, real environment.

5. The method of claim 1, further comprising monitoring the virtual universe for the customer need request.

6. The method of claim 1, wherein the virtual interactive menu comprises at least one link to a data repository.

7. The method of claim 1, wherein the providing a customer service representative avatar further comprises:
providing an automated interactive session between customer service representative avatar and the avatar.

8. The method of claim 1, upon the customer service representative avatar satisfying at least one aspect of the customer need request, returning the avatar to one of: the virtual menu and web page.

9. The method of claim 1, further comprising querying the avatar if the customer need request is satisfied.

10. The method of claim 1, wherein at least one of the receiving, presenting, and providing are in a virtual commerce setting.

11. The method of claim 1, wherein the customer need request is evidenced by an action, text, a voice, or combinations thereof.

12. The method of claim 1, further comprising storing a response from the avatar to at least one of: the virtual interactive menu, the web page, and the customer service representative avatar.

13. A system for providing customer service hierarchies within a virtual universe, comprising:
a component for receiving a customer need request from an avatar;
a component for presenting at least one of:
a virtual interactive menu, and
a web page; and
a component for providing a customer service representative avatar if the presenting does not satisfy the customer need request.

14. The system of claim 13, if the customer service representative avatar does not satisfy the customer need request, further comprising a component for providing a live, real-time customer server representative.

15. The system of claim 13, further comprising a component for monitoring the virtual universe for the customer need request.

16. The system of claim 13, further comprising a component for querying the avatar if the customer need request is satisfied.

17. The system of claim 13, further comprising a component for storing a response from the avatar to at least one of: the virtual interactive menu, the web page, and the customer service representative avatar.

18. A program product stored on a computer readable medium, which when executed, provides customer service hierarchies within a virtual universe, the computer readable medium comprising program code for:
receiving a customer need request from an avatar;
upon the receiving, presenting at least one of:
a virtual interactive menu, and
a web page; and
if the presenting does not satisfy the customer need request, providing a customer service representative avatar.

19. The program product of claim 18, the program code further comprising: if the customer service representative avatar does not satisfy the customer need request, providing a live, real-time customer server representative.

20. The program product of claim 19, the program code further comprising: upon the live customer service representative satisfying at least one aspect of the customer need request, returning the avatar to one of: the virtual menu, the web page, and the customer service representative avatar.

21. The program product of claim 18, the program code further comprising: upon the customer service representative avatar satisfying at least one aspect of the customer need request, returning the avatar to one of: the virtual menu and web page.

22. The program product of claim 18, the program code further comprising: querying the avatar if the customer need request is satisfied.

23. The program product of claim 18, the program code further comprising: wherein the customer need request is evidenced an action, text, a voice, or combinations thereof.

24. The program product of claim 18, the program code further comprising: storing a response from the avatar to at least one of: the virtual interactive menu, the web page, and the customer service representative avatar.

25. A method for deploying an application for providing customer service hierarchies within a virtual universe, comprising:
providing a computer infrastructure being operable to:
receive a customer need request from an avatar;
upon the receiving, present at least one of:
a virtual interactive menu, and
a web page; and
if the presenting does not satisfy the customer need request,
provide a customer service representative avatar.
